(19) United States
(12) Patent Application Publication
(10) Pub. No.: US 2022/0271318 A1
(43) Pub. Date: Aug. 25, 2022

(54) FUEL CELL STACK AND METHOD OF ASSEMBLING FUEL CELL STACK

(71) Applicant: HONDA MOTOR CO., LTD., Tokyo (JP)

(72) Inventor: Hideharu NAITO, WAKO-SHI (JP)

(21) Appl. No.: 17/665,557

(22) Filed: Feb. 6, 2022

(30) Foreign Application Priority Data
Feb. 24, 2021 (JP) 2021-027899

(51) Int. Cl. H01M 8/248; H01M 8/2404

(52) U.S. Cl. CPC H01M 8/248; H01M 8/2404

(57) ABSTRACT

The fuel cell stack includes a stacked body formed of a plurality of power generation cells stacked one another, a pair of end plates, and a positioning pin for positioning the plurality of power generation cells. One end of the positioning pin is provided with a first screw part which is screw-engaged with the end plate. The other end of the positioning pin is provided with a second screw part into which the extension pin is screw-engaged. The screw tightening direction of the second screw part is the reverse of the screw tightening direction of the first screw part.

### CROSS-REFERENCE TO RELATED APPLICATIONS

This application is based upon and claims the benefit of priority from Japanese Patent Application No. 2021-027899 filed on Feb. 24, 2021, the contents of which are incorporated herein by reference.

### BACKGROUND OF THE INVENTION

### Field of the Invention

The present invention relates to a fuel cell stack and a method of assembling a fuel cell stack.

### Description of the Related Art

For example, JP 2014-132558 A discloses a fuel cell stack. The fuel cell stack includes a stacked body in which a plurality of power generation cells (unit cells) are stacked one another, and end plates disposed at both ends of the stacked body in a stacking direction. Each of the power generation cells is formed with a positioning hole into which a positioning pin (knock pin) is insertable. In assembling the fuel cell stack, a predetermined number of power generation cells are stacked while the positioning pin is inserted into the positioning holes formed in each of the plurality of power generation cells. A tightening load is applied to the stacked body in the stacking direction. Thus, the fuel cell stack can be assembled.

JP 2013-196849 A discloses the following in relation to the positioning pin. A plurality of power generation cells are compressed in the stacking direction by using a positioning shaft having a main body part (positioning pin) and an extension part (extension pin). After this compression step, the extension part is removed from the main body part. According to such a method of assembling a fuel cell stack, it is possible to easily form a fuel cell stack without an unnecessarily protruded positioning shaft.

### SUMMARY OF THE INVENTION

It is an object of the present invention to provide a fuel cell stack and a method of assembling a fuel cell stack capable of efficiently removing an extension pin from a positioning pin.

In a first aspect of the present invention, a fuel cell stack includes a stacked body formed of a plurality of power generation cells stacked one another, first and second end plates arranged at both ends of the stacked body in a stacking direction, a positioning pin configured to be inserted through respective positioning holes formed in the plurality of power generation cells for positioning the plurality of power generation cells, wherein the positioning pin has one end and another end, the one end being provided with a first screw part in screw engagement with the first end plate, the another end being provided with a second screw part configured to be screw-engaged with an extension pin, and a screw tightening direction of the first screw part and a screw tightening direction of the second screw part are reverse directions (the first screw part and the second screw part are reverse-thread screws).

In a second aspect of the present invention, there is provided a method of assembling a fuel cell stack including a stacked body formed of a plurality of power generation cells stacked one another, first and second end plates arranged at both ends of the stacked body in a stacking direction, a positioning pin configured to be inserted through respective positioning holes formed in the plurality of power generation cells for positioning the plurality of power generation cells, wherein the positioning pin has one end and another end, the one end being provided with a first screw part, the another end being provided with a second screw part having a screw tightening direction the reverse of that of the first screw part, the method includes a pin arrangement step of arranging the first screw part of the positioning pin in a state where the first screw part is in screw engagement with the first end plate while forming a positioning shaft by connecting an extension pin to the second screw part of the positioning pin by screw engagement, a stacking step of stacking the plurality of power generation cells while passing the positioning shaft through the positioning holes after the pin arrangement step, a compression step of compressing the stacked body in the stacking direction by applying a tightening load to the plurality of power generation cells in the stacking direction after the stacking step, and an extension pin removing step of removing the extension pin from the positioning pin after the compression step.

According to the present invention, the screw tightening direction of the second screw part provided at the other end of the positioning pin is a direction the reverse of the screw tightening direction of the first screw part. Therefore, when the extension pin is removed from the positioning pin in assembling the fuel cell stack, the positioning pin can be prevented from rotating together with the extension pin. That is, it is possible to prevent the extension pin from failing to be detached from the positioning pin due to loosening of the positioning pin from the first end plate. Therefore, the extension pin can be efficiently removed from the positioning pin.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a partially exploded perspective view shown in a fuel cell stack according to an embodiment of the present invention;

FIG. 2 is a partially omitted vertical cross-sectional view of the fuel cell stack shown in FIG. 1;

FIG. 3 is an exploded perspective view of a power generation cell shown in FIG. 1;

FIG. 4A is a partially omitted exploded perspective view for illustrating a rotation regulating mechanism;

FIG. 4B is a lateral cross-sectional view for illustrating the rotation regulating mechanism of FIG. 4A;

FIG. 5 is a flowchart illustrating a method of assembling a fuel cell stack;

FIG. 6 is an explanatory diagram of a pin arrangement step;

FIG. 7 is a partially omitted cross-sectional view of a positioning shaft;

FIG. 8 is a schematic explanatory diagram of a stacking step;

FIG. 9 is a schematic explanatory diagram of a compression step; and

FIG. 10 is a schematic explanatory diagram of an extension pin removing step.

### DESCRIPTION OF THE INVENTION

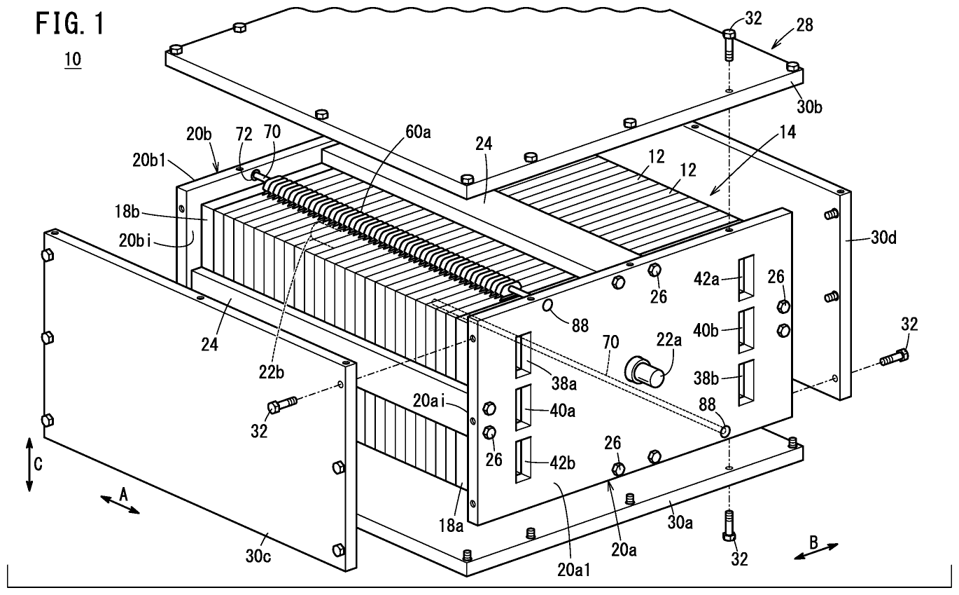

As shown in FIG. 1, a fuel cell stack 10 according to the present embodiment includes a stacked body 14 formed by stacking a plurality of power generation cells 12 (unit cells) one another. The fuel cell stack 10 is mounted on a fuel cell vehicle (not shown). However, the fuel cell stack 10 can also be used as a stationary type.

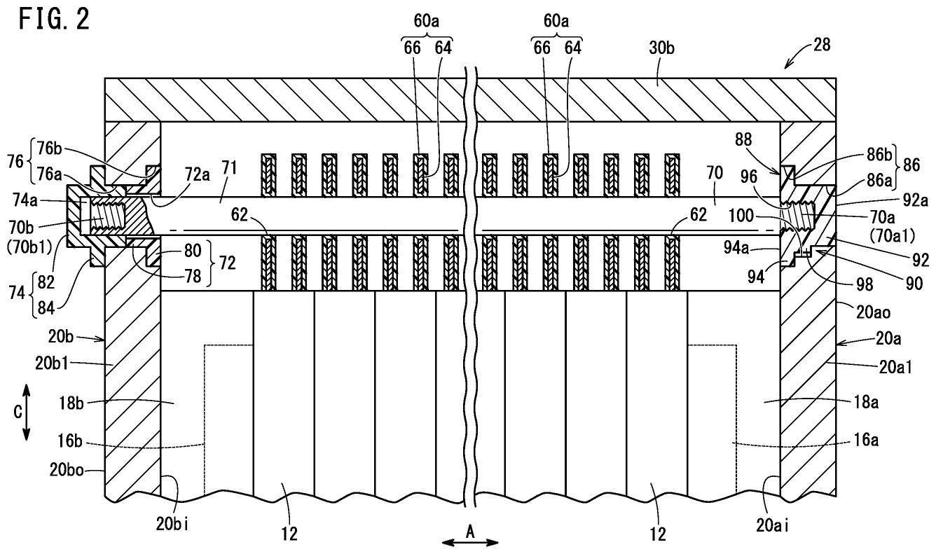

In FIGS. 1 and 2, a terminal plate 16a, an insulator 18a, and an end plate 20a (first end plate) are disposed outward in this order at one end of the stacked body 14 in the stacking direction (direction of arrow A). At the other end of the stacked body 14 in the stacking direction, a terminal plate 16b, an insulator 18b, and an end plate 20b (second end plate) are disposed outward in this order.

That is, the pair of end plates 20a and 20b are positioned at both ends of the stacked body 14 in the stacking direction. An output terminal 22a is provided substantially at the center of the end plate 20a. The output terminal 22a is connected to the terminal plate 16a and extends outward in the stacking direction. An output terminal 22b is provided substantially at the center of the end plate 20b. The output terminal 22b is connected to the terminal plate 16b and extends outward in the stacking direction.

As shown in FIG. 1, each of the end plates 20a and 20b (to be specific, end plate main bodies 20a1 and 20b1 to be described later) is made of metal and has a horizontally long rectangular shape. A coupling member 24 (coupling bar) is disposed between each side of the end plate 20a and each side of the end plate 20b. Both ends of each connecting member 24 are fixed to the inner surfaces 20ai and 20bi of the end plates 20a and 20b by bolts 26. Thus, the coupling member 24 applies a tightening load to the stacked body 14 in the stacking direction (arrow A direction).

The fuel cell stack 10 includes a cover portion 28 that covers the stacked body 14 from directions orthogonal to the stacking direction. The cover portion 28 includes a pair of side panels 30a and 30b and a pair of side panels 30c and 30d. The side panels 30a and 30b are provided on the long sides of the end plates 20a and 20b and have a horizontally long plate shape. The side panels 30c and 30d are provided on short sides of the end plates 20a and 20b, and have a horizontally long plate shape. The side panels 30a to 30d are fixed to the side surfaces of the end plates 20a and 20b by bolts 32. The cover portion 28 may be integrally formed by casting or extrusion. The cover portion 28 may be used as necessary, or may be omitted.

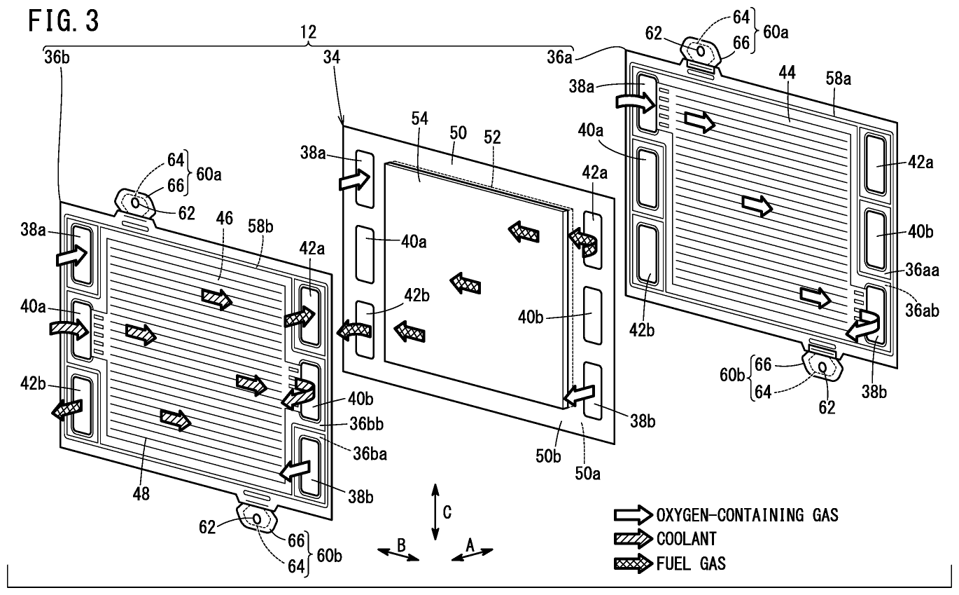

As shown in FIG. 3, the power generation cell 12 includes an MEA 34 (membrane electrode assembly), and a first separator 36a and a second separator 36b sandwiching the MEA 34.

An oxygen-containing gas supply passage 38a, a coolant supply passage 40a, and a fuel gas discharge passage 42b are provided at one end of the power generation cell 12 in the direction indicated by arrow B, which is parallel to the long side of the power generation cell 12. The passages 38a, 40a, and 42b are arranged along the direction of arrow C. The oxygen-containing gas supply passage 38a allows an oxygen-containing gas to flow therethrough. The coolant supply passage 40a allows a coolant, such as pure water, ethylene glycol, or oil, to flow therethrough. The fuel gas discharge passage 42b allows a fuel gas, such as a hydrogen-containing gas, to flow therethrough.

The oxygen-containing gas supply passages 38a provided in the plurality of power generation cells 12 are in communication with each other in the stacking direction (the direction indicated by arrow A). The coolant supply passages 40a provided in the plurality of power generation cells 12 communicate with each other in the stacking direction. The fuel gas discharge passages 42b provided in the plurality of power generation cells 12 communicate with each other in the stacking direction.

A fuel gas supply passage 42a, a coolant discharge passage 40b, and an oxygen-containing gas discharge passage 38b are provided at the other end of the power generation cell 12 in the direction indicated by arrow B. The passages 42a, 40b, and 38b are arranged along the direction of arrow C. The fuel gas supply passage 42a allows the fuel gas to flow therethrough. The coolant discharge passage 40b allows the coolant to flow therethrough. The oxygen-containing gas discharge passage 38b allows the oxygen-containing gas to flow therethrough.

The fuel gas supply passages 42a provided in the plurality of power generation cells 12 communicate with each other in the stacking direction. The coolant discharge passages 40b provided in the plurality of power generation cells 12 communicate with each other in the stacking direction. The oxygen-containing gas discharge passages 38b provided in the power generation cells 12 communicate with each other in the stacking direction.

The oxygen-containing gas supply passage 38a, the oxygen-containing gas discharge passage 38b, the fuel gas supply passage 42a, the fuel gas discharge passage 42b, the coolant supply passage 40a, and the coolant discharge passage 40b are formed in the insulator 18a and the end plate 20a as well (see FIG. 1).

The arrangement of the oxygen-containing gas supply passage 38a, the oxygen-containing gas discharge passage 38b, the fuel gas supply passage 42a, the fuel gas discharge passage 42b, the coolant supply passage 40a, and the coolant discharge passage 40b is not limited to that in this embodiment. The arrangement of these passages may be appropriately set in accordance with required specifications.

The first separator 36a has a surface 36aa facing the MEA 34. The surface 36aa is provided with an oxygen-containing gas flow field 44 that communicates with the oxygen-containing gas supply passage 38a and the oxygen-containing gas discharge passage 38b. The oxygen-containing gas flow field 44 has a plurality of oxygen-containing gas flow grooves extending in the direction indicated by arrow B.

The second separator 36b has a surface 36ba facing the MEA 34. The surface 36ba is provided with a fuel gas flow field 46 that communicates with the fuel gas supply passage 42a and the fuel gas discharge passage 42b. The fuel gas flow field 46 has a plurality of fuel gas flow grooves extending in the direction of arrow B.

The surface 36ab of the first separator 36a and the 36bb of the second separator 36b face each other. A coolant flow field 48 is formed between the surfaces 36ab and 36bb. The coolant flow field 48 has a plurality of coolant flow grooves extending in the arrow B direction.

The MEA 34 includes, for example, an electrolyte membrane 50 (solid polymer electrolyte membrane) which is a thin film of perfluorosulfonic acid containing water, and a cathode 52 and an anode 54 which sandwich the electrolyte membrane 50.

In addition to the fluorine-based electrolyte, an HC (hydrocarbon)-based electrolyte may be used for the electrolyte membrane 50. The electrolyte membrane 50 has a larger planar dimension (outer dimension) than those of the cathode 52 and the anode 54. That is, the electrolyte membrane 50 protrudes outward from the cathode 52 and the anode 54.

The cathode 52 is joined to one surface 50a of the electrolyte membrane 50. The anode 54 is joined to the other surface 50b of the electrolyte membrane 50. Each of the cathode 52 and the anode 54 includes an electrode catalyst layer and a gas diffusion layer. The electrode catalyst layer is formed by uniformly applying a paste containing porous carbon particles having a platinum alloy carried by surfaces thereof and an ion conductive component, to the surface of the gas diffusion layer. The gas diffusion layer is made of carbon paper, carbon cloth, or the like.

In the MEA 34, the planar dimension of the electrolyte membrane 50 may be smaller than the planar dimensions of the cathode 52 and the anode 54. In this case, a resin film (resin frame member) having a frame shape may be sandwiched between the outer peripheral portion of the cathode 52 and the outer peripheral portion of the anode 54.

Each of the first separator 36a and the second separator 36b is formed in a rectangular shape (quadrangular shape) such that the flow direction of the reactant gas extends along the long side thereof. Each of the first separator 36a and the second separator 36b is formed by press-forming a steel plate, a stainless steel plate, an aluminum plate, or a plated steel plate so as to have a corrugated cross section, for example. Alternatively, the first separator 36a and the second separator 36b are formed by press-forming a metal thin plate subjected to an anti-corrosion surface treatment so as to have a corrugated cross section. The outer peripheries of the first separator 36a and the second separator 36b are integrally joined by welding, brazing, caulking, or the like in a state where the surface 36ab and the surface 36bb face each other.

A first seal line 58a is formed on the outer peripheral of the first separator 36a. The first seal line 58a bulges toward the MEA 34. The first seal line 58a prevents the fluid (fuel gas, oxygen-containing gas, and coolant) from leaking to the outside from between the first separator 36a and the MEA 34. That is, the protruding end face of the first seal line 58a comes into direct contact with the surface 50a of the electrolyte membrane 50, and the first seal line 58a is elastically deformed. The first seal line 58a is configured as a metal bead seal. However, the first seal line 58a may be formed of a rubber seal member having elasticity.

A second seal line 58b is formed on the outer peripheral portion of the second separator 36b. The second seal line 58b bulges toward the MEA 34. The second seal line 58b prevents leakage of the fluid (fuel gas, oxygen-containing gas, and coolant) from between the second separator 36b and the MEA 34. That is, the protruding end face of the second seal line 58b comes into direct contact with the surface 50b of the electrolyte membrane 50, and the second seal line 58b is elastically deformed. The second seal line 58b is configured as a metal bead seal. However, the second seal line 58b may be formed of a rubber seal member having elasticity.

The first separator 36a is provided with two protruded portions 60a and 60b protruding outward from the outer periphery of the first separator 36a. The protruded portion 60a is formed at one outer edge of the first separator 36a in the arrow C direction. The protruded portion 60a is formed at a position close to one end of the outer edge in the arrow B direction (a position close to the oxygen-containing gas supply passage 38a). The protruded portion 60b is formed at the other outer edge of the first separator 36a in the arrow C direction. The protruded portion 60b is formed at a position close to the other end of the outer edge in the arrow B direction (a position close to the oxygen-containing gas discharge passage 38b).

A positioning hole 62 through which a positioning pin 70 (see FIGS. 1 and 2) described later is inserted is formed in a substantially central portion of the protruded portion 60a. In FIG. 3, the positioning pin 70 is omitted from the illustration.

As shown in FIGS. 2 and 3, the protruded portion 60a includes a support portion 64 formed in a plate shape and an insulating portion 66 covering the support portion 64. The support portion 64 is formed of a metal material (for example, the same material as the first separator 36a). The support portion 64 is welded to the first separator 36a. However, the support portion 64 may be integrally formed with the first separator 36a. The positioning hole 62 is formed in the insulating portion 66 covering the support portion 64.

The insulating portion 66 is made of an electrically insulating material such as resin. The insulating portion 66 covers a portion of the support portion 64 protruding from the first separator 36a. A wall portion forming the positioning hole 62 is formed of the insulating portion 66 (insulating material).

The protruded portion 60b is configured similarly to the protruded portion 60a. Therefore, detailed descriptions of the configuration of the protruded portion 60b will be omitted. Similarly to the first separator 36a, the second separator 36b is provided with two protruded portions 60a and 60b. In other words, each power generation cell 12 has two protruded portions 60a and two protruded portions 60b.

The fuel cell stack 10 shown in FIG. 2 includes two positioning pins 70 (knock pins) for positioning the plurality of power generation cells 12 with respect to each other. The positioning pins 70 are inserted into the positioning holes 62 in the protruded portion 60a and 60b of each power generation cell 12. In the example shown in FIG. 2, the positioning pins 70 are positioned outside the insulators 18a and 18b and do not penetrate through the insulators 18a and 18b. The positioning pin 70 may penetrate through the insulators 18a and 18b.

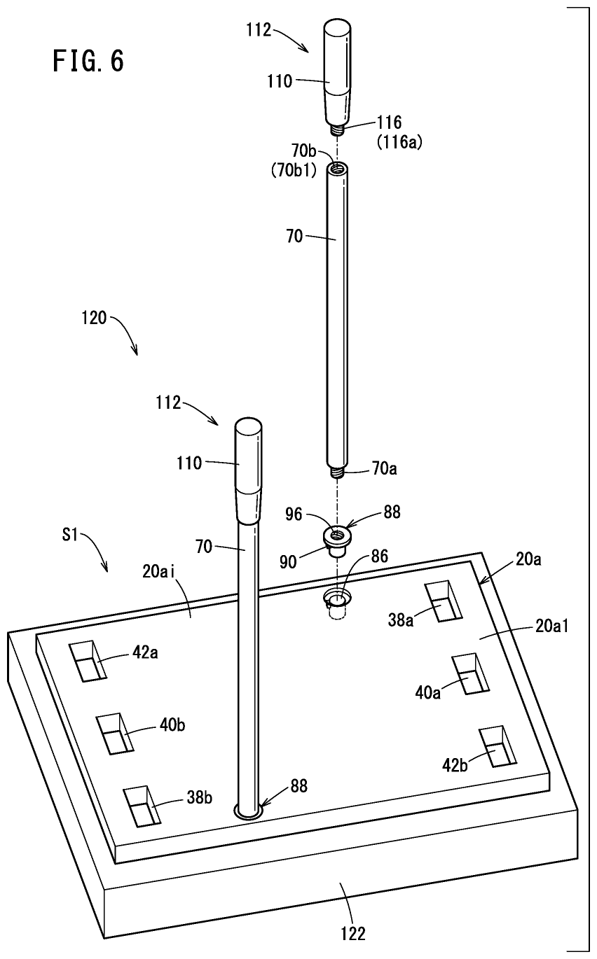

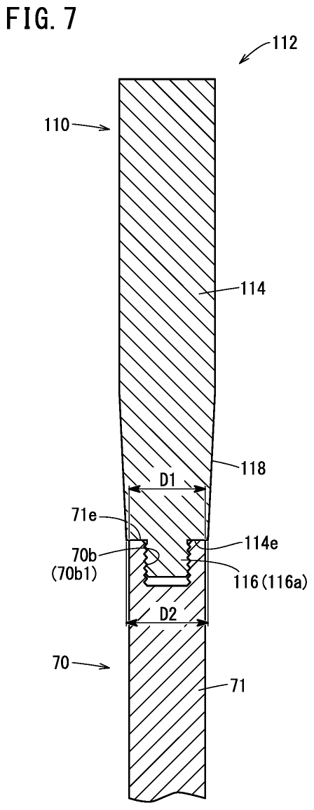

The positioning pin 70 is formed of a metal material such as iron, stainless steel, aluminum, titanium, or magnesium and shaped into a columnar shape or a cylindrical shape. A first screw part 70a is provided at one end of the positioning pin 70. The first screw part 70a is screw-engaged with a collar member 88, which will be described later, provided on the end plate 20a. A second screw part 70b is provided at the other end of the positioning pin 70. An extension pin 110 (see FIGS. 6 and 7) to be described later is screw-engaged into the second screw part 70b. Accordingly, the positioning pin 70 includes a positioning pin main body 71 inserted into the positioning holes 62, the first screw part 70a having a smaller radius than the positioning pin main body 71, and the second screw part 70b having a smaller radius than the positioning pin main body 71.

In the present embodiment, the first screw part 70a is a male screw 70a1. In another embodiment, the first screw part 70a may be an internal thread. The end plate 20a includes a metal end plate body 20a1 and a resin collar member 88 fixed to the end plate body 20a1. The above-described passages (such as the oxygen-containing gas inlet supply passage 38a shown in FIGS. 1 and 2) are formed in the end plate body 20a1.

The end plate 20b includes an end plate body 20b1, and a first support member 72 and a second support member 74 fixed to the end plate body 20b1. The above-described passages (such as the oxygen-containing gas supply passage 38a shown in FIGS. 1 and 2) are formed in the end plate body 20b1. The other end portion of the positioning pin 70 is supported by the first support member 72 and the second support member 74. In the present embodiment, the second screw part 70b is a female screw 70b1. In another embodiment, the second screw part 70b may be an external thread.

The screw tightening direction of the second screw part 70b and the screw tightening direction of the first screw part 70a are reverse directions. That is, the threading direction (helical direction) of the second screw part 70b is the reverse of the threading direction (helical direction) of the first screw part 70a. Specifically, in the present embodiment, the first screw part 70a is a right-hand thread and the second screw part 70b is a left-hand thread. In another embodiment, the first screw part 70a may be a left-hand thread, and the second screw part 70b may be a right-hand thread.

The first support member 72 and the second support member 74 are inserted into through-holes 76 formed in the second end plate 20b. The through-hole 76 is a stepped hole including a small-diameter hole 76a and a large-diameter hole 76b. The small-diameter hole 76a opens to the outer surface 20bo of the end plate 20b. The large-diameter hole 76b communicates with the small-diameter hole 76a and opens to the inner surface 20bi of the end plate 20b.

The first support member 72 is formed in a tubular shape. That is, the first support member 72 has an inner hole 72a into which the other end portion of the positioning pin 70 is inserted. The first support member 72 includes a cylindrical first support body 78 inserted into one end portion of the small-diameter hole 76a, and a first annular portion 80 provided to the first support body 78 and inserted into the large-diameter hole 76b. The first annular portion 80 extends radially outward from an axial end (an end close to the stacked body 14) of the first support body 78.

The second support member 74 is formed in a bottomed tubular shape. That is, the second support member 74 has a recessed portion 74a into which the other end portion of the positioning pin 70 is inserted. The second support member 74 includes a cylindrical second support body 82 inserted into the other end portion of the small-diameter hole 76a and a second annular portion 84 provided to the second support body 82. One end face of the second support body 82 is close to an end face of the first support body 78. The other end side (bottom portion side) of the second support body 82 is positioned outside the end plate 20b and covers the other end of the positioning pin 70. The second annular portion 84 extends radially outward from a substantially central portion of the second support body 82 in the axial direction. The second annular portion 84 is in contact with the outer surface 20bo of the end plate 20b.

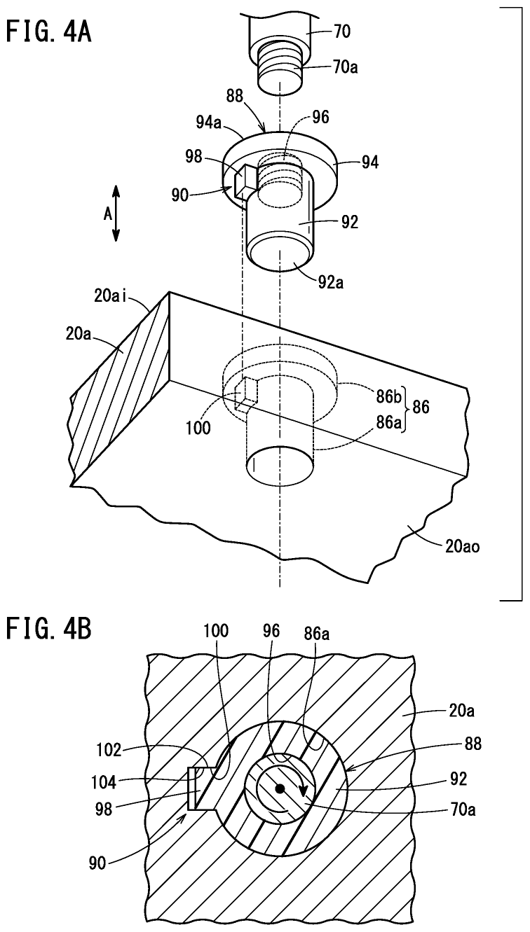

As shown in FIGS. 2, 4A, and 4B, the fuel cell stack 10 includes the collar member 88 and a rotation regulating mechanism 90. The collar member 88 is inserted into a through-hole 86 formed in the end plate 20a.

The through-hole 86 is a stepped hole including a small-diameter insertion hole 86a and a large-diameter flange hole 86b. The insertion hole 86a opens to an outer surface 20ao of the end plate 20a. The flange hole 86b communicates with the insertion hole 86a and opens to the inner surface 20ai of the end plate 20a. The collar member 88 is made of an insulating material (material having electrical insulating properties). The collar member 88 includes a columnar collar body 92 and a flange portion 94 provided on the collar body 92.

The collar body 92 is inserted into the insertion hole 86a. The end face 92a of the collar body 92 is flush with the outer surface 20ao of the end plate 20a (see FIG. 2). However, the end face 92a of the collar body 92 may be positioned further inward in the stacking direction of the stacked body 14 than the outer surface 20ao of the end plate 20a. The end face 92a may be positioned outside the outer surface 20ao of the end plate 20a in the stacking direction of the stacked body 14. An outer diameter of the collar body 92 is substantially the same as an inner diameter (hole diameter) of the insertion hole 86a. The collar body 92 may be formed in a cylindrical shape.

The flange portion 94 is inserted into the flange hole 86b. The flange portion 94 protrudes radially outward from an axial end (an end close to the stacked body 14) of the collar body 92 and extends annularly. A female screw 96 (screw hole) into which the first screw part 70a of the positioning pin 70 is to be screw-engaged is formed substantially at the center of the outer surface 94a of the flange portion 94. In another embodiment, when the first screw part 70a is internally threaded, the collar member 88 is provided with a male screw.

The rotation regulating mechanism 90 restricts rotation of the collar member 88 relative to the end plate 20a along the screw tightening direction (the direction of the arrow in FIG. 4B) of the positioning pin 70. The rotation regulating mechanism 90 includes a projection 98 projecting radially outward from an outer peripheral surface of the collar body 92 and a groove 100 formed in a wall surface defining the insertion hole 86a.

The length of the projection 98 projected from the collar body 92 is shorter than the length of the flange portion 94 projected from the collar body 92. The length of the projection 98 can be arbitrarily set. The projection 98 is formed in a rectangular parallelepiped shape, and extends from the flange portion 94 toward the end face 92a of the collar body 92.

That is, in FIG. 4B, the cross section of the projection 98 is formed in a substantially quadrangular shape. The projection 98 is positioned radially outward of the female screw 96 (see FIG. 2). A first abutting surface 102 is formed on an end of the projection 98 positioned on the leading side in the screw tightening direction of the positioning pin 70. The first abutting surface 102 is formed flat.

As shown in FIGS. 2, 4A, and 4B, the groove 100 extends along the axial direction of the collar body 92. The projection 98 is inserted into the groove 100. The groove 100 has a shape corresponding to the shape of the projection 98 (rectangular parallelepiped shape). In FIG. 4B, a wall portion forming the groove 100 is formed with a second abutting surface 104 abutting on the first abutting surface 102. The second abutting surface 104 is formed flat and extends parallel to the first abutting surface 102.

The shapes of the projection 98 and the groove 100 can be arbitrarily set. The cross-section of the projection 98 may be triangular or polygonal (other than quadrangular). The groove 100 may not be formed in a shape corresponding to the projection 98 as long as the projection 98 can be inserted (rotation of the collar body 92 can be restricted). The phases of the projection 98 and the groove 100 in the circumferential direction of the collar body 92 are not particularly limited as long as the projection 98 can be inserted into the groove 100.

For example, the rotation regulating mechanism 90 may adopt other configurations as described below.

In another embodiment (first modified example) of the rotation regulating mechanism 90, the collar member 88 has a male screw formed on the outer peripheral surface of the collar body 92. An inner surface forming the through-hole 86 in the end plate body 20a1 has a female screw to be screw-engaged with the male screw. In still another embodiment (second modified example) of the rotation regulating mechanism 90, the collar member 88 has a flange portion having a non-circular shape (for example, an oval shape or a polygonal shape). The end plate body 20a1 has a non-circular groove into which the flange portion is fitted (engaged). In yet another embodiment (third modified example) of the rotation regulating mechanism 90, the collar member 88 has a projecting pin that protrudes in the axial direction from the flange portion 94. The end plate main body 20a1 has a hole into which the projecting pin is inserted. In still another aspect (fourth modified example) of the rotation regulating mechanism 90, the collar member 88 is insert-molded in the 20a1 of the end plate main body. In yet another embodiment (fifth modified example) of the rotation regulating mechanism 90, the collar member 88 has a plurality of projections protruding radially outward from the outer peripheral surface of the collar body 92. The plurality of projections bite into an inner wall surface forming the through hole 86.

Next, a method of assembling the fuel cell stack 10 will be described.

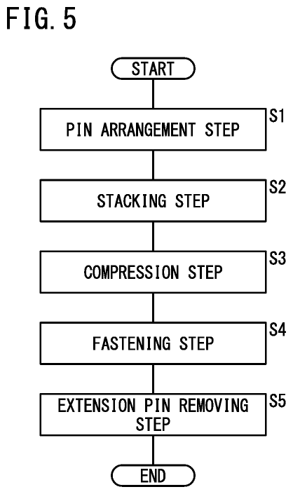

As shown in FIG. 5, the assembling method of the fuel cell stack 10 includes a pin arrangement step S1, a stacking step S2, a compression step S3, a fastening step S4, and an extension pin removing step S5.

In the pin arrangement step S1, as shown in FIG. 6, the extension pin 110 is connected to the second screw part 70b of the positioning pin 70 by screw engagement to form a positioning shaft 112, and the first screw part 70a of the positioning pin 70 is screw-engaged with the end plate 20a. In the pin arrangement step S1, the first screw part 70a is positioned at the lower end of the positioning pin 70, and the second screw part 70b is positioned at the upper end of the positioning pin 70. That is, the positioning pin 70 is arranged along the vertical direction.

As shown in FIG. 7, the positioning shaft 112 has the positioning pin 70 and the extension pin 110 that is screw-engageable with the positioning pin 70. The extension pin 110 is connected to the other end portion (end portion provided with the second screw part 70b) of the positioning pin 70, whereby the positioning shaft 112 having a longer overall length than the positioning pin 70 is formed. The cross-sectional shape of the positioning pin 70 perpendicular to the axial direction is round. The cross-sectional shape of the extension pin 110 perpendicular to the axial direction is round.

The outer diameter of the positioning pin main body 71 is constant over the entire length. Accordingly, the outer diameter of the positioning pin main body 71 is the same as the outer diameter D2 of an end face 114e of an extension pin main body 114, which will be described later, over the entire length.

The extension pin 110 includes the extension pin main body 114 and a third screw part 116. The third screw part 116 is smaller than the extension pin main body 114 in diameter and is screw-engageable with the second screw part 70b. The extension pin main body 114 has the end face 114e adjacent to the positioning pin main body 71. The positioning pin main body 71 has an end face 71e adjacent to the extension pin main body 114. In the positioning shaft 112, the outer diameter D2 of the end face 114e of the extension pin main body 114 is larger than the outer diameter D1 of the end face 71e of the positioning pin main body 71. A difference (D2−D1) between the outer diameter D2 of the end face 114e of the extension pin main body 114 and the outer diameter D1 of the end face 71e of the positioning pin main body 71 is, for example, about 20 to 100 μm.

The extension pin main body 114 has a tapered portion 118 whose outer diameter decreases toward the end face 114e of the extension pin main body 114. The inclination angle of the tapered portion 118 with respect to the axis of the extension pin 110 is set to, for example, 0.4 to 1.0 degrees.

In the present embodiment, the third screw part 116 is a male screw 116a. As described above, in another embodiment, when the second screw part 70b is a male screw, the third screw part 116 needs to be a female screw.

In FIG. 6, the end plate 20a is fixed on a base 122 of a stack assembling apparatus 120 by an appropriate fixing member such as bolts (not shown). The inner surface 20ai of the end plate 20a faces upward (in a direction opposite to the base 122). The positioning pin 70 is connected to the collar member 88 by screw engagement between the first screw part 70a of the positioning pin 70 and the female screw 96 of the collar member 88 of the end plate 20a. In this case, either of the following first method and second method may be adopted. In the first method, the positioning shaft 112 with the extension pin 110 connected to the positioning pin 70 is connected to the collar member 88. In the second method, the positioning pin 70 to which the extension pin 110 has not been connected is first connected to the collar member 88, and then the extension pin 110 is connected to the positioning pin 70.

As described above, in the pin arrangement step S1, the first screw part 70a of the positioning pin 70 is screw-engaged with the female screw 96 of the collar member 88. At this time, a screw tightening force in the direction of the arrow shown in FIG. 4B acts on the collar member 88. However, rotation of the collar member 88 is restricted by the rotation regulating mechanism 90 in the screw tightening direction of the positioning pin 70. Since the first abutting surface 102 of the projection 98 is in abutment with the second abutting surface 104 of the groove 100, the collar member 88 does not rotate in the screw tightening direction of the positioning pin 70. Therefore, an operator (user) can efficiently attach the positioning pin 70 to the collar member 88.

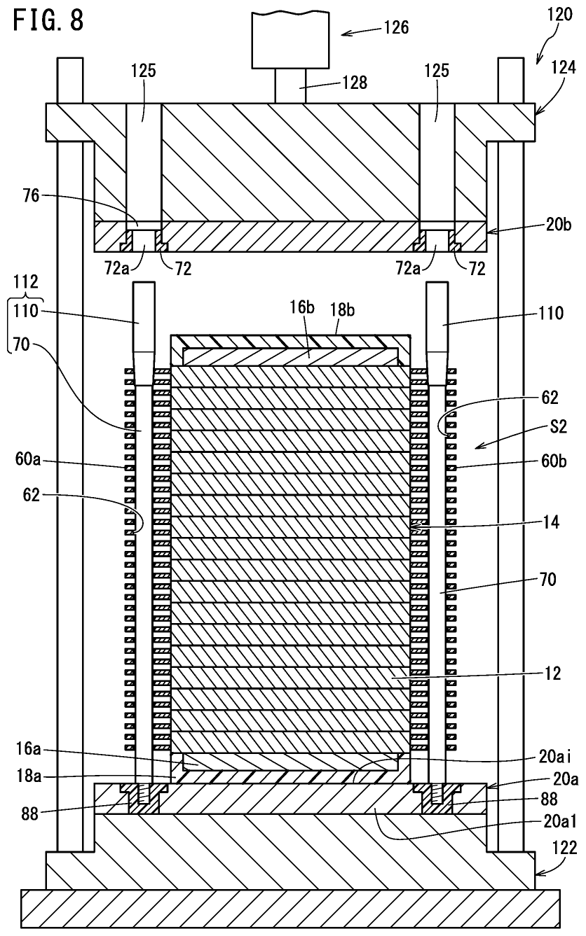

As shown in FIG. 8, in the stacking step S2, the plurality of power generation cells 12 are stacked while the positioning shafts 112 are inserted into the positioning holes 62 of the power generation cells 12. In particular, the power generation cell 12 is moved toward the end plate 20a (vertically downward) along the positioning shafts 112. The plurality of power generation cells 12 are stacked on the insulator 18a and the terminal plate 16a superposed on an inner surface 20ai of an end plate 20a. After a predetermined number of power generation cells 12 are stacked, the terminal plate 16b and the insulator 18b are stacked on the other end (upper end) of the stacked body 14. In FIG. 8, the other end plate 20b is fixed to the lower surface of a pressing plate 124 of the stack assembling apparatus 120 by an appropriate fixing member such as bolts (not shown). The through-hole 76 formed in the end plate 20b communicates with a hole portion 125 provided in the pressing plate 124.

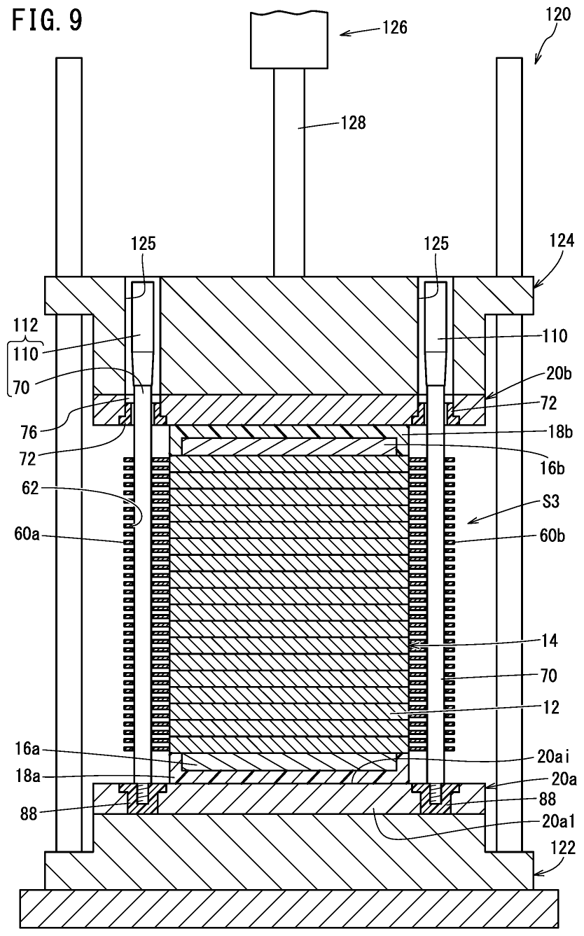

After the stacking step S2, a compression step S3 is performed (see FIG. 5). As shown in FIG. 9, in the compression step S3, a tightening load in the stacking direction is applied to the plurality of power generation cells 12 to compress the stacked body 14 in the stacking direction. To be more specific, a rod 128 of a cylinder mechanism 126 of the stack assembling apparatus 120 is extended to lower the pressing plate 124, thereby sandwiching the stacked body 14 between the pair of end plates 20a and 20b. As a result, a tightening load in the stacking direction is applied to the stacked body 14. Due to this tightening load, the distance between the pair of end plates 20a and 20b is set to a predetermined distance. In order to adjust the tightening load, a shim plate (not shown) may be interposed between the end plate 20b and the insulator 18b.

In FIG. 9, a predetermined tightening load is applied to the stacked body 14 by the pressing plate 124. In this state, the other end portion (the upper end portion in this state) of the positioning pin 70 is inserted into the through-hole 76 provided in the end plate 20b, and the extension pin 110 is inserted into the hole portion 125 provided in the pressing plate 124.

After the compression step S3, the fastening step S4 is performed (see FIG. 5). In the fastening step S4, the pair of end plates 20a and 20b are coupled to each other by the coupling member 24 (see FIG. 1) in a state in which the distance between the pair of end plates 20a and 20b are maintained at the predetermined distance described above by the application of the tightening load (the state of FIG. 9). As a result, the distance between the pair of end plates 20a and 20b is restricted, and the plurality of power generation cells 12 are held in a predetermined compressed state. Thus, the fastening step S4 is completed.

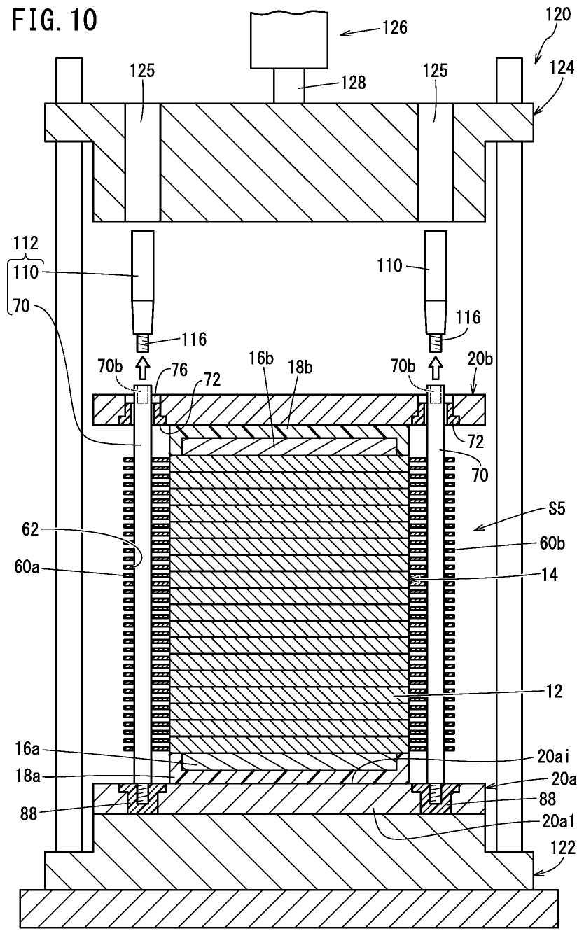

After the fastening step S4, an extension pin removing step S5 is performed (see FIG. 5). As shown in FIG. 10, in the extension pin removing step S5, the extension pin 110 is removed from the positioning pin 70. In detail, the tightening load applied on the end plate 20b by the pressing plate 124 of the stack assembling apparatus 120 is released. Next, the pressing plate 124 is raised to separate the pressing plate 124 from the end plate 20b and expose the extension pin 110.

Next, the extension pin 110 protruding upward from the end plate 20b is rotated with respect to the positioning pin 70. As a result, the screw engagement (see FIG. 7) between the second screw part 70b of the positioning pin 70 and the third screw part 116 of the extension pin 110 is released. At this time, the rotational direction in which the positioning pin 70 and the extension pin 110 are unscrewed is the same direction as the screw tightening direction of the positioning pin 70. Therefore, when the extension pin 110 is rotated in the screw releasing direction, the rotation of the positioning pin 70 is limited by the end plate 20a (the collar member 88). Therefore, the positioning pin 70 does not rotate together with the rotation of the extension pin 110 and the screw engagement between the positioning pin 70 and the collar member 88 is not loosened.

After the extension pin removing step S5, as shown in FIG. 1, the side panels 30a, 30b, 30c, 30d are fixed to the end plates 20a and 20b to complete the assembly of the fuel cell stack 10.

Next, the operation of the fuel cell stack 10 will be described.

First, as shown in FIG. 1, the oxygen-containing gas is supplied to the oxygen-containing gas supply passage 38a in the end plate 20a. The fuel gas is supplied to the fuel gas supply passage 42a of the end plate 20a. The coolant is supplied to the coolant supply passage 40a in the end plate 20a.

As shown in FIG. 3, the oxygen-containing gas is introduced from the oxygen-containing gas supply passage 38a into the oxygen-containing gas flow field 44 of the first separator 36a. The oxygen-containing gas flows in the direction indicated by arrow B along the oxygen-containing gas flow field 44 and is supplied to the cathode 52 of the membrane electrode assembly.

On the other hand, the fuel gas is introduced from the fuel gas supply passage 42a into the fuel gas flow field 46 of the second separator 36b. The fuel gas moves in the direction of arrow B along the fuel gas flow field 46 and is supplied to the anode 54 of the membrane electrode assembly.

Therefore, in each MEA 34, the oxygen-containing gas supplied to the cathode 52 and the fuel gas supplied to the anode 54 are consumed by the electrochemical reaction. Thus, power is generated.

Subsequently, the remainder of the oxygen-containing gas supplied to and consumed at the cathode 52 is discharged in the direction of arrow A along the oxygen-containing gas discharge passage 38b. Similarly, the remainder of the fuel gas supplied to and consumed at the anode 54 is discharged in the direction of arrow A along the fuel gas discharge passage 42b.

The coolant supplied to the coolant supply passage 40a is introduced into the coolant flow field 48 formed between the first separator 36a and the second separator 36b. The coolant introduced into the coolant flow field 48 flows in the direction of arrow B. After cooling the MEA 34, the coolant is discharged from the coolant discharge passage 40b.

The present embodiment has the following effects.

As shown in FIG. 2, the screw tightening direction of the second screw part 70b provided at the other end portion of the positioning pin 70 is the reverse of the screw tightening direction of the first screw part 70a. Therefore, in assembling the fuel cell stack 10, when the extension pin 110 is removed from the positioning pin 70 as shown in FIG. 10, the positioning pin 70 can be prevented from rotating together with the extension pin 110. That is, it is possible to prevent the extension pin 110 from failing to be detached from the positioning pin 70 due to loosening of the positioning pin 70 from the end plate 20a (in particular, from the collar member 88). Therefore, the extension pin 110 can be efficiently removed from the positioning pin 70.

As shown in FIG. 2, since the first screw part 70a is a male screw 70a1, the screw engagement with the end plate 20a can be easily performed. Since the second screw part 70b is a female screw 70b1, an increase in the overall length of the positioning pin 70 by providing the second screw part 70b can be avoided.

As shown in FIGS. 4A and 4B, a rotation regulating mechanism 90 is provided. The rotation regulating mechanism 90 restricts rotation of the collar member 88 relative to the end plate main body 20a1 along the screw tightening direction of the positioning pin 70 with respect to the collar member 88. In this way, rotation of the collar member 88 relative to the end plate 20a along the screw tightening direction of the positioning pin 70 is restricted by the rotation regulating mechanism 90. Therefore, when the positioning pin 70 is screwed to the collar member 88, the collar member 88 can be prevented from rotating together with the positioning pin 70. Thus, the positioning pin 70 can be efficiently attached to the collar member 88.

As shown in FIG. 7, the positioning pin 70 includes the positioning pin main body 71 and a second screw part 70b having a diameter smaller than the positioning pin main body 71. The extension pin 110 has the extension pin main body 114 and the third screw part 116 which is smaller than the extension pin main body 114 in diameter and is screw-engageable with the second screw part 70b. In the positioning shaft 112, an outer diameter D2 of the end face 114e of the extension pin main body 114 adjacent to the positioning pin main body 71 is larger than the outer diameter D1 of the end face 71e of the positioning pin main body 71 adjacent to the extension pin main body 114. With this configuration, when the power generation cells 12 are stacked as illustrated in FIG. 8, the positioning holes 62 are prevented from being caught by a step formed at a connection portion between the positioning pin 70 and the extension pin 110 of the positioning shaft 112. This makes it possible to efficiently stack the power generation cells 12.

As shown in FIG. 7, the extension pin main body 114 has the tapered portion 118 whose outer diameter decreases toward the end face 114e of the extension pin main body 114. Thus, when the power generation cells 12 are stacked as shown in FIG. 8, the positioning holes 62 can be smoothly guided along the extension pins 110 to the positioning pins 70.

The above embodiments can be summarized as follows.

The present embodiment discloses the fuel cell stack (10) including the stacked body (14) formed of the plurality of power generation cells (12) stacked one another, the first and second end plates (20a, 20b) arranged at both ends of the stacked body in the stacking direction, the positioning pin (70) configured to be inserted through respective positioning holes (62) formed in the plurality of power generation cells for positioning the plurality of power generation cells, wherein the positioning pin has one end and another end, the one end being provided with the first screw part (70a) in screw engagement with the first end plate, the another end being provided with the second screw part (70b) configured to be screw-engaged with the extension pin (110), and a screw tightening direction of the first screw part and a screw tightening direction of the second screw part are reverse directions.

The first screw part is the male screw (70a1), and the second screw part is the female screw (70b1).

The first end plate includes the metal end plate body (20a1) and the resin collar member (88) fixed to the end plate body, and the first screw part is screw-engaged with the female screw (96) provided in the collar member.

The first end plate has the rotation regulating mechanism (90) for restricting rotation of the collar member with respect to the end plate body along a screw tightening direction of the positioning pin with respect to the collar member.

The present embodiment discloses the method of assembling the fuel cell stack (10) including the stacked body (14) formed of a plurality of power generation cells (12) stacked one another, the first and second end plates (20a, 20b) arranged at both ends of the stacked body in the stacking direction, the positioning pin (70) configured to be inserted through respective positioning holes (62) formed in the plurality of power generation cells for positioning the plurality of power generation cells, wherein the positioning pin has one end and another end, the one end being provided with the first screw part (70a), the another end being provided with the second screw part (70b) having the screw tightening direction the reverse of the screw tightening direction of the first screw part, the method includes the pin arrangement step (S1) of arranging the first screw part of the positioning pin in a state where the first screw part is in screw engagement with the first end plate while forming the positioning shaft (112) by connecting the extension pin (110) to the second screw part of the positioning pin by screw engagement, the stacking step (S2) of stacking the plurality of power generation cells while passing the positioning shaft through the positioning holes after the pin arrangement step, the compression step (S3) of compressing the stacked body in the stacking direction by applying the tightening load to the plurality of power generation cells in the stacking direction after the stacking step, and the extension pin removing step (S5) of removing the extension pin from the positioning pin after the compression step.

The first screw part is the male screw (70a1), and the second screw part is the female screw (70b1).

In the pin arrangement step, the first screw part is positioned at the lower end of the positioning pin, and the second screw part is positioned at the upper end of the positioning pin.

The positioning pin includes the positioning pin main body (71) and the second screw part having the diameter smaller than the positioning pin main body, and the extension pin includes the extension pin main body (114) and the third screw part (116) having the diameter smaller than the extension pin main body and capable of being screw-engaged with the second screw part, and in the positioning shaft, the outer diameter (D2) of the end face (114e) of the extension pin main body adjacent to the positioning pin main body is larger than the outer diameter (D1) of the end face (71e) of the positioning pin main body adjacent to the extension pin main body.

The extension pin main body has the tapered portion (118) having the outer diameter decreasing toward the end face of the extension pin main body.

The present invention is not limited to the embodiments described above, and various modifications are possible without departing from the essence and gist of the invention.

What is claimed is:

1. A fuel cell stack comprising: a stacked body formed of a plurality of power generation cells stacked one another; first and second end plates arranged at both ends of the stacked body in a stacking direction; and a positioning pin configured to be inserted through respective positioning holes formed in the plurality of power generation cells for positioning the plurality of power generation cells,
wherein the positioning pin has one end and another end, the one end being provided with a first screw part in screw engagement with the first end plate, the another end being provided with a second screw part configured to be screw-engaged with an extension pin, and
a screw tightening direction of the second screw part and a screw tightening direction of the first screw part are reverse directions.

2. The fuel cell stack according to claim 1,
wherein the first screw part is a male screw and the second screw part is a female screw.

3. The fuel cell stack according to claim 2,
wherein the first end plate comprises a metal end plate body and a resin collar member fixed to the end plate body,
the first screw part is screw-engaged with a female screw provided in the collar member.

4. The fuel cell stack according to claim 3,
wherein the first end plate comprises a rotation regulating mechanism that restricts rotation of the collar member relative to the end plate main body along the screw tightening direction of the positioning pin with respect to the collar member.

5. A method of assembling a fuel cell stack comprising: a stacked body formed of a plurality of power generation cells stacked one another, first and second end plates arranged at both ends of the stacked body in the stacking direction, a positioning pin configured to be inserted through respective positioning holes formed in the plurality of power generation cells for positioning the plurality of power generation cells,
wherein the positioning pin has one end and another end, the one end being provided with a first screw part, the another end being provided with the second screw part having a tightening direction reverse of a tightening direction of the first screw part,
the method comprising:
a pin arrangement step of arranging the first screw part of the positioning pin in a state where the first screw part is in screw engagement with the first end plate while forming a positioning shaft by connecting the extension pin to the second screw part of the positioning pin by screw engagement;
a stacking step of stacking the plurality of power generation cells while passing the positioning shaft through the positioning holes after the pin arrangement step;
a compression step of compressing the stacked body in the stacking direction by applying a tightening load to the plurality of power generation cells in the stacking direction after the stacking step; and
an extension pin removing step of removing the extension pin from the positioning pin after the compression step.

6. The method of assembling a fuel cell stack according to claim 5,
wherein the first screw part is a male screw, and the second screw part is a female screw.

7. The method of assembling a fuel cell stack according to claim 6,
wherein in the pin arrangement step, the first screw part is positioned at a lower end of the positioning pin, and the second screw part is positioned at an upper end of the positioning pin.

8. The method of assembling a fuel cell stack according to claim 5,
wherein the positioning pin includes a positioning pin main body and the second screw part having a diameter smaller than a diameter of the positioning pin main body, and
wherein the extension pin includes an extension pin main body and a third screw part having a diameter smaller than a diameter of the extension pin main body and is screw-engageable with the second screw part,
wherein in the positioning shaft, an outer diameter of an end face of the extension pin main body adjacent to the positioning pin main body is larger than an outer diameter of an end face of the positioning pin body adjacent to the extension pin main body.

9. The method of assembling a fuel cell stack according to claim 8,
wherein the extension pin main body has a tapered portion having an outer diameter decreasing toward the end face of the extension pin main body.
